(19) United States
(12) Patent Application Publication
(10) Pub. No.: US 2026/0086589 A1
(43) Pub. Date: Mar. 26, 2026

(54) ELECTRONIC CIRCUITRY

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Norihiro UEDA, Kawasaki (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/063,548

(22) Filed: Feb. 26, 2025

(30) Foreign Application Priority Data
Sep. 20, 2024 (JP) 2024-164420

(51) Int. Cl. G05F 1/573; H02H 9/02

(52) U.S. Cl. CPC G05F 1/573; H02H 9/025

(57) ABSTRACT

According to one embodiment, an electronic circuitry comprises a first transistor connected between an input voltage line and an output terminal, an input voltage being supplied to the input voltage line; and a current limiting circuit configured to limit an output current of the first transistor to a limiting current or less by restricting a variable range of a drive voltage of the first transistor within a predetermined range, the limiting current being determined by a reference voltage having a dependency on the input voltage.

### CROSS REFERENCE TO RELATED APPLICATIONS

This application is based upon and claims the benefit of priority from the prior Japanese Patent Application No. 2024-164420, filed on Mar. 20, 2024, the entire contents of which are incorporated herein by reference.

### FIELD

Embodiments relate to an electronic circuitry.

### BACKGROUND

A linear regulator controls an on-resistance of an output transistor provided between an input voltage line and an output terminal to reduce an input voltage and output a predetermined constant voltage. A typical linear regulator includes a current limiting circuit that limits an output current of the output transistor to a predetermined value or less. The current limiting circuit limits a variable range of a drive voltage of the output transistor within a predetermined range, thereby controlling the output current of the output transistor to be equal to or less than a predetermined value.

A voltage equivalent to a difference between the input voltage and the output voltage is applied between a drain and a source of the output transistor, but the output voltage is fixed to a constant value, whereas the input voltage can take any value equal to or greater than the output voltage. For this reason, the drain-source voltage of the output transistor changes depending on the input voltage, and the output current changes accordingly. As a result, an output current limiting function of the linear regulator has a dependency on the input voltage.

### BRIEF DESCRIPTION OF THE DRAWINGS

FIG. 1 is a diagram illustrating a configuration of a linear regulator according to a first embodiment;

FIG. 2 is a graph illustrating characteristics of currents Ip, Is, and In;

FIG. 3 is a graph illustrating characteristics of a second reference current Is;

FIG. 4 is a graph illustrating drain-source voltage/current characteristics of a diode-connected transistor;

FIG. 5 is a graph illustrating drain-source voltage/current characteristics of an output transistor;

FIG. 6 is a graph illustrating the most preferable state of dependency characteristics of a current Ip and an output current Io on a power supply voltage;

FIG. 7 is a diagram illustrating a configuration of a linear regulator according to a second embodiment;

FIG. 8 is a diagram illustrating a configuration of a linear regulator according to a third embodiment;

FIG. 9 is a diagram illustrating a configuration of a linear regulator according to a fourth embodiment;

FIG. 10 is a diagram illustrating a configuration of a linear regulator according to a fifth embodiment;

FIG. 11 is a diagram illustrating a configuration of a linear regulator according to a sixth embodiment;

FIG. 12 is a diagram illustrating a configuration of a linear regulator according to a comparative embodiment;

FIG. 13 is a graph illustrating drain-source voltage/current characteristics of a diode-connected transistor; and

FIG. 14 is a graph illustrating drain-source voltage/current characteristics of an output transistor.

### DETAILED DESCRIPTION

According to one embodiment, an electronic circuitry comprises a first transistor connected between an input voltage line and an output terminal, an input voltage being supplied to the input voltage line; and a current limiting circuit configured to limit an output current of the first transistor to a limiting current or less by restricting a variable range of a drive voltage of the first transistor within a predetermined range, the limiting current being determined by a reference voltage having a dependency on the input voltage.

According to one embodiment, an electronic circuitry comprises: a first transistor connected between an input voltage line and an output terminal, an input voltage being supplied to the input voltage line; a second transistor connected between the input voltage line and a first node; a current limiting circuit including a third diode-connected transistor and an error amplifier; a constant current circuit configured to keep a total of a reference current and an output current of the second transistor constant; and a first voltage fixing circuit connected to the third transistor and configured to fix a voltage of the first node to a predetermined first setting voltage.

According to one embodiment, aan electronic circuitry comprises a first transistor connected between an input voltage line and an output terminal, an input voltage being supplied to the input voltage line; a second transistor connected to the input voltage line and a first node; a third diode-connected transistor configured to generate a reference voltage by generating a reference current corresponding to the input voltage; a current limiting circuit configured to limit an output current of the first transistor to a limiting current or less by restricting a variable range of a drive voltage of the first transistor within a predetermined range, the limiting current depending on the reference voltage; a constant current circuit configured to keep a total of the reference current and an output current of the second transistor constant; and a second voltage fixing circuit configured to fix a drain-source voltage of the second transistor to a predetermined second setting voltage.

Hereinafter, embodiments will be described with reference to the drawings. In the drawings, the same or corresponding components are designated by the same reference numerals, and detailed descriptions thereof will not be given as appropriate.

### COMPARATIVE EMBODIMENT

Before descriptions of linear regulators according to the present embodiments, a linear regulator according to a comparative embodiment will be described and problems thereof will be discussed.

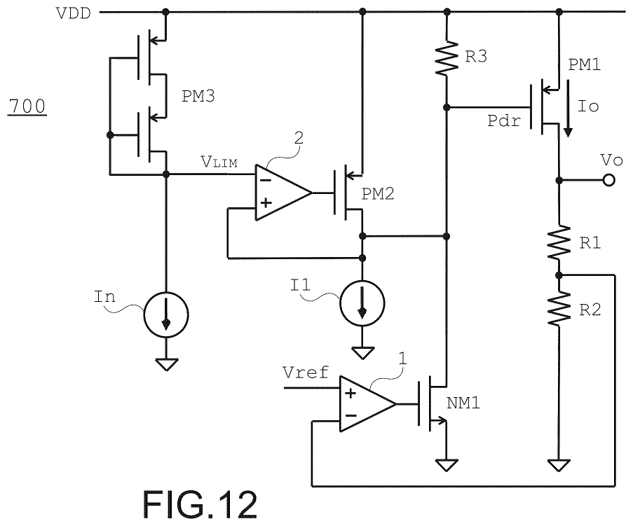

FIG. 12 is a diagram illustrating a configuration of a linear regulator 700 according to the comparative embodiment. The linear regulator 700 includes a voltage control circuit that maintains an output voltage Vo at a predetermined constant value. The voltage control circuit includes an output transistor PM1 (a first transistor), resistors R1 to R3, an error amplifier 1, and a transistor NM1. A source of the output transistor PM1 is connected to an input voltage line VDD, and a drain of the output transistor PM1 is connected to an output terminal Vo. The resistors R1 and R2 are connected in series between the output terminal Vo and a ground, and divide the output voltage Vo at a predetermined ratio to generate a divided voltage Vd.

The error amplifier 1 compares the divided voltage Vd with a reference voltage Vref. When the divided voltage Vd is lower than the reference voltage Vref, the error amplifier 1 outputs a positive voltage and the transistor NM1 enters an ON state. Whereby, a current flows from the input voltage line VDD through a drain-source of the transistor NM1 to the ground, and a voltage drop across the resistor R3 increases. As a result, a drive voltage Pdr of the output transistor PM1 reduces, on-resistance between the drain and the source reduces, and thus the output voltage Vo rises.

Conversely, when the divided voltage Vd is higher than the reference voltage Vref, the error amplifier 1 outputs a negative voltage and the transistor NM1 enters an OFF state. Whereby, a current does not flow from the input voltage line VDD through the drain-source of the transistor NM1 to the ground, and the voltage drop across the resistor R3 decreases. As a result, the drive voltage Pdr of the output transistor PM1 rises, the on-resistance between the drain and the source increases, and thus the output voltage Vo reduces.

By the operation of the voltage control circuit described above, the output voltage Vo of the linear regulator 700 is maintained at a constant value that satisfies the following relational expression.

$$\begin{matrix}[ Equation 1 ] & \\ {V}_{O} = {V}_{ref} ( 1 + \frac{{R}_{1}}{{R}_{2}} ) & ( 1 )\end{matrix}$$

Further, the linear regulator 700 includes a current limiting circuit that limits an output current Io of the output transistor PM1 to a predetermined value or less. The current limiting circuit includes an error amplifier 2, a transistor PM2, a constant current source I1, a diode-connected transistor PM3 (a third transistor), and a first reference current source In. By the constant current source I1, a constant current I1 flows from the input voltage line VDD through the resistor R3 and the constant current source I1 to the ground. A reference voltage V_{LIM} is generated by the diode-connected transistor PM3 and the first reference current source In.

The error amplifier 2 compares the drive voltage Pdr of the output transistor PM1 with the reference voltage V_{LIM}. When the output voltage Vo reduces and the voltage drop across the resistor R3 increases due to the operation in the case where the divided voltage Vd is lower than the reference voltage Vref as described above, the drive voltage Pdr of the output transistor PM1 becomes lower than the reference voltage V_{LIM}, so that the output voltage of the error amplifier 2 decreases and the transistor PM2 enters an ON state. Thus, a current flows from the input voltage line VDD through a drain-source of the transistor PM2 and a drain-source of the transistor NM1 to the ground, and in exchange, the current flowing through the resistor R3 stagnates and the voltage drop across the resistor R3 stagnates. As a result, the decrease in the drive voltage Pdr of the output transistor PM1 stagnates, and the increase in the output current Io thereof is hindered.

Conversely, when the output voltage Vo rises and the voltage drop across the resistor R3 decreases due to the operation in the case where the divided voltage Vd is higher than the reference voltage Vref as described above, the drive voltage Pdr of the output transistor PM1 becomes higher than the reference voltage V_{LIM}, so that the output voltage of the error amplifier 2 rises and the transistor PM2 enters an OFF state. As a result, the stagnation of the decrease in the drive voltage Pdr of the output transistor PM1 is resolved, and the increase in the output current Io thereof is not hindered.

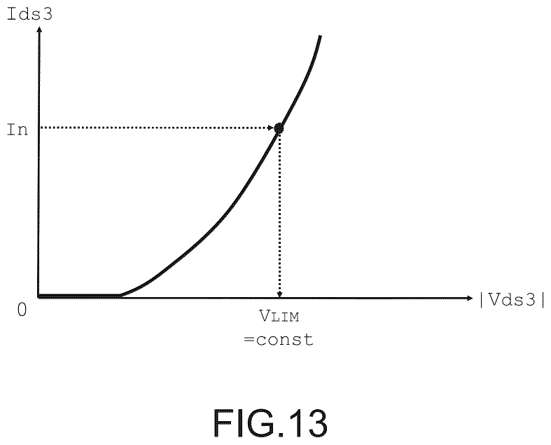

FIG. 13 is a graph illustrating voltage-current characteristics between a drain and a source of the diode-connected transistor PM3. A vertical axis Ids3 represents a current between the drain and the source of the transistor PM3. A horizontal axis Vds3 represents a voltage between the drain and the source of the transistor PM3. A voltage value between the drain and the source of the transistor PM3, that is, the reference voltage V_{LIM} is a function only of the first reference current In, which is a current value flowing between the drain and the source, and is expressed by Equation (2) below.

$$\begin{matrix}[ Equation 2 ] & \\ {V}_{LIM} = \sqrt{\frac{{I}_{n}}{\frac{1}{2} {μ}_{p} {C}_{ox} \frac{{W}_{3}}{{L}_{3}}}} + {V}_{th} & ( 2 )\end{matrix}$$

Here, L3 and W3 indicate a gate length and a gate width of the transistor PM3, respectively, μp indicates positive-carrier mobility, Cox indicates a gate oxide film capacitance per unit area, and Vth indicates a threshold voltage.

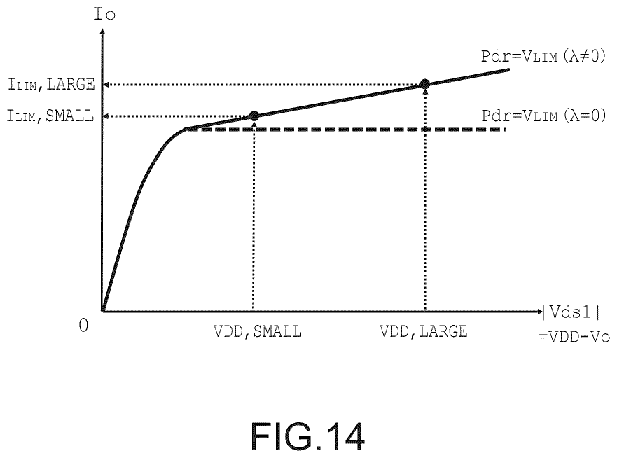

FIG. 14 is a graph illustrating drain-source voltage/current characteristics of the output transistor PM1 at a given drive voltage Pdr=V_{LIM}. A vertical axis Io represents a current between the drain and the source of the output transistor PM1. A horizontal axis Vds1 represents a voltage between the drain and the source of the output transistor PM1. A solid line represents actual characteristics in which a channel length modulation effect exists, and a broken line represents ideal characteristics in which the channel length modulation effect does not exist. A current value between the drain and the source of the output transistor PM1, that is, the output current Io, is a function of a voltage Vds1, which is a voltage value between the drain and the source, and is expressed by Equation (3) below.

$$\begin{matrix}[ Equation 3 ] & \\ {I}_{o} = \frac{1}{2} {μ}_{p} {C}_{ox} \frac{{W}_{1}}{{L}_{1}} {( {V}_{LIM} - {V}_{th} )}^{2} ( 1 + {λ}_{1} {V}_{ds 1} ) & ( 3 )\end{matrix}$$

Here, L1 and W1 indicate a gate length and a gate width of the output transistor PM1, respectively, and \1 indicates a channel length modulation coefficient.

When Equation (1) is substituted into Equation (3), the output current Io of the output transistor PM1 is limited to a limiting current I_{LIM} or less expressed by Equation (4) below.

$$\begin{matrix}[ Equation 4 ] & \\ {I}_{LIM} = \frac{{W}_{1} / {L}_{1}}{{W}_{3} / {L}_{3}} ( 1 + {λ}_{1} {V}_{ds 1} ) {I}_{n} & ( 4 )\end{matrix}$$

In Equation (4), the drain-source voltage Vds1 of the output transistor PM1 is a difference between the input voltage VDD and the output voltage Vo, that is, |Vds1|=VDD−Vo. The output voltage Vo is fixed to a constant value, whereas the input voltage VDD can take any value equal to or greater than the output voltage Vo.

In the ideal characteristic (λ1=0) where the channel length modulation effect does not exist as indicated by the broken line in FIG. 14, Equation (4) does not depend on Vds1. However, in the actual characteristic (λ1≠0) where the channel length modulation effect exists as indicated by the solid line in FIG. 14, Equation (4) depends on Vds1, and the limiting current I_{LIM} changes as the input voltage VDD changes. Specifically, the limiting current I_{LIM} increases as the input voltage VDD increases. Therefore, the output current limiting function of the linear regulator 700 according to the comparative embodiment has a dependency on the input voltage VDD.

### First Embodiment

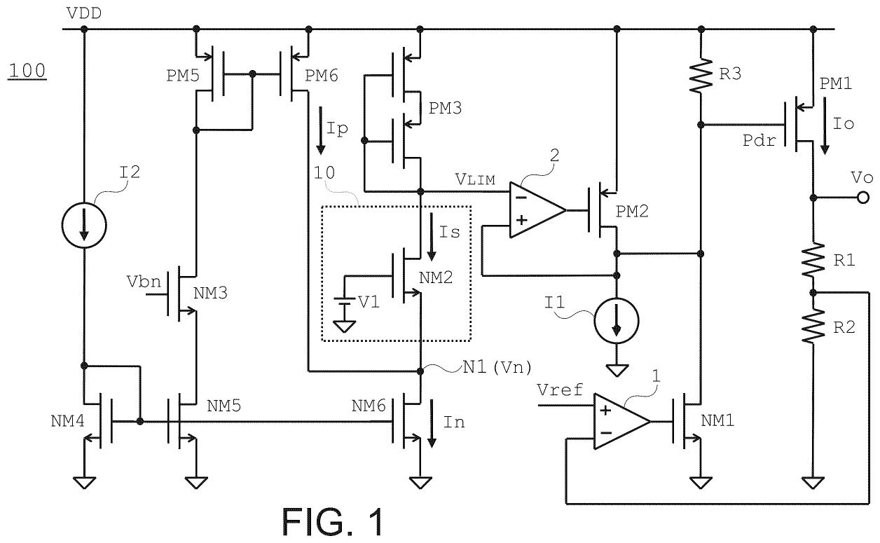

FIG. 1 is a diagram illustrating a configuration of a linear regulator 100 according to a first embodiment. The linear regulator 100 includes a current mirror circuit formed by a transistor PM5 and a transistor PM6 (a second transistor) and a first voltage fixing circuit 10 formed by a transistor NM2 (a fourth transistor), in addition to the components of the linear regulator 700 according to the comparative embodiment. Sources of the transistors PM5 and PM6 are connected to an input voltage line VDD. A drain of the transistor PM6 is connected to a first node N1.

A drain of the transistor NM2 forming the first voltage fixing circuit 10 is connected to a drain of a diode-connected transistor PM3. A source of the transistor NM2 is connected to the first node N1. A constant voltage source V1 is connected to a gate of the transistor NM2. The constant voltage source V1 generates a voltage obtained by adding a threshold voltage Vth to a predetermined setting voltage Vn (first setting voltage). Accordingly, when a first reference current In flowing downstream of the first node N1 is a constant value as will be described below, a change in voltage of the first node N1 becomes extremely small, and the voltage of the first node N1 is substantially fixed to the setting voltage Vn. In the first embodiment, the setting voltage Vn is set to be equal to the output voltage Vo, that is, Vn=Vo. The “fixed” in the present embodiment not only means that the voltage is completely fixed to the set value, but also means that a slight change in voltage near the set value is allowed.

Further, the linear regulator 100 includes a constant current source 12, a cascode current mirror circuit formed by transistors NM3 to NM5, and a current mirror circuit formed by transistors NM4 and NM6. A value of a drain-source current Ip of the transistor PM6 is determined by an aspect ratio of each of the transistors NM3 to NM5 forming the cascode current mirror circuit. A value of the first reference current In flowing downstream of the first node N1 is determined by an aspect ratio of each of the transistors NM4 and NM6 forming the current mirror circuit. A second reference current Is corresponding to a difference between the first reference current In and the current Ip flows between the drain and the source of the diode-connected transistor PM3.

A drain-source voltage Vds6 of the transistor PM6 is a difference between the input voltage VDD and the setting voltage Vn of the first node N1, that is, |Vds6|=VDD−Vn. The setting voltage (Vn=Vo) of the first node N1 is fixed to a constant value, whereas the input voltage VDD can take any value equal to or greater than the output voltage Vo. Therefore, similarly to the output transistor PM1, the drain-source current Ip of the transistor PM6 depends on the input voltage VDD, and the current Ip becomes large as the input voltage VDD becomes large.

The current mirror circuit formed by the transistors NM4 and NM6 functions as a constant current circuit that keeps the first reference current In at a constant value. Specifically, the transistors NM4 and NM6 are designed to have a long gate length or are formed by a plurality of cascode-connected transistors. Thus, the first reference current In flowing between the drain and the source of the transistor NM6 is almost not affected by the channel length modulation effect and has a constant value. Therefore, the following relationship is established among the currents Ip, Is, and In according to a current conservation law at the first node N1.

$$\begin{matrix}[ Equation 5 ] & \\ {I}_{p} + {I}_{s} = {I}_{n} = const & ( 5 )\end{matrix}$$

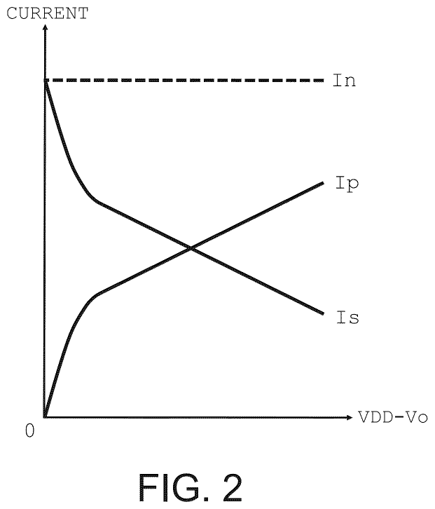

FIG. 2 is a graph illustrating characteristics of the currents Ip, Is, and In. A horizontal axis of the graph represents a difference between the input voltage VDD and the output voltage Vo, where the output voltage Vo is fixed to a constant value and only the input voltage VDD changes. The first reference current In does not depend on the input voltage VDD and has a constant value. The current Ip depends on the input voltage VDD, and the current Ip becomes large as the input voltage VDD becomes large. The second reference current Is also depends on the input voltage VDD, and the second reference current Is becomes small as the input voltage VDD becomes large, contrary to the current Ip.

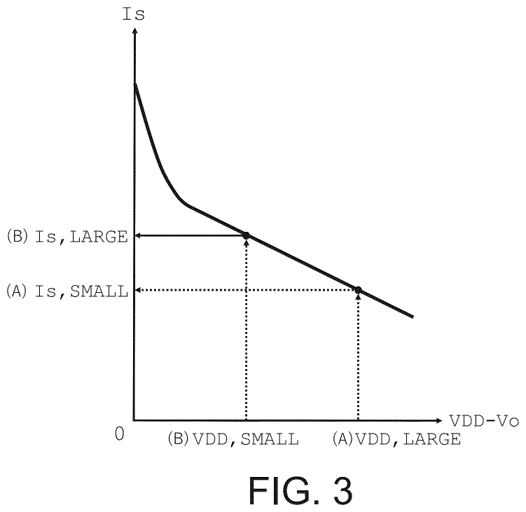

FIG. 3 is a graph illustrating only the characteristics of the second reference current Is from FIG. 2. The second reference current Is becomes small as the input voltage VDD becomes large ((A) in the drawing), and the second reference current Is becomes large as the input voltage VDD becomes small ((B) in the drawing).

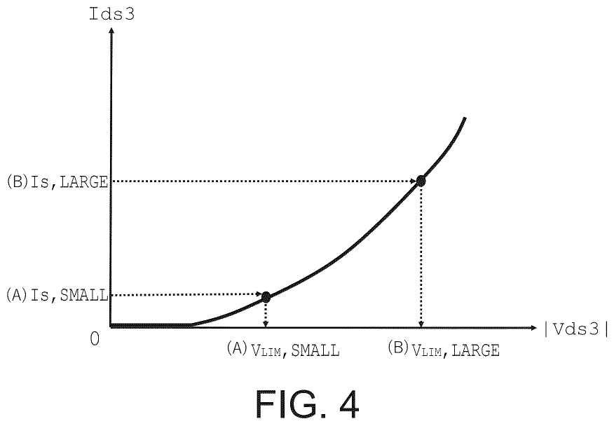

FIG. 4 is a graph illustrating drain-source voltage/current characteristics of the diode-connected transistor PM3. A drain-source voltage Vds3 of the transistor PM3, that is, the reference voltage V_{LIM}, is determined only by a drain-source current Ids3, that is, the second reference current Is. Specifically, the reference voltage V_{LIM} becomes small as the second reference current Is is small ((A) in the drawing), and the reference voltage V_{LIM} becomes large as the second reference current Is is large ((B) in the drawing).

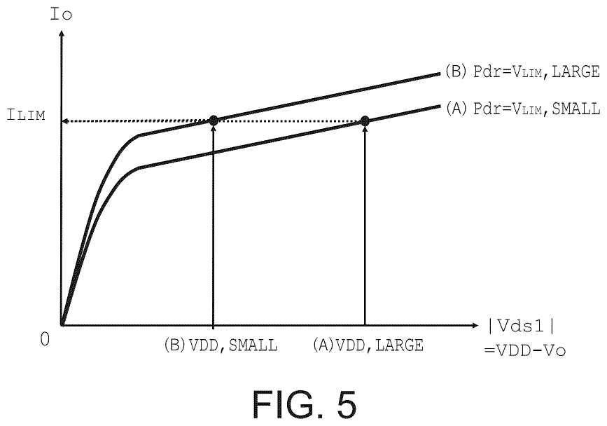

FIG. 5 is a graph illustrating drain-source voltage/current characteristics of the output transistor PM1. A drain-source current Io of the output transistor PM1 depends on the drive voltage Pdr and the drain-source voltage |Vds1|=VDD−Vo. Therefore, the limiting current I_{LIM} depends on the reference voltage V_{LIM} and the input voltage VDD. Specifically, when the reference voltage V_{LIM} is small, the characteristic graph shifts downward ((A) in the drawing), and when the reference voltage V_{LIM} is large, the characteristic graph shifts upward ((B) in the drawing). As a result, the limiting current I_{LIM} when the input voltage VDD is large ((A) in the drawing) is substantially equal in magnitude to the limiting current I_{LIM} when the input voltage VDD is small ((B) in the drawing).

To summarize the above operation, when the input voltage VDD is large, the second reference current Is and the reference voltage V_{LIM} become small and the limiting current I_{LIM} becomes small. Conversely, when the input voltage VDD is small, the second reference current Is and the reference voltage V_{LIM} become large and the limiting current IUM becomes large. In other words, when the magnitude of the input voltage VDD changes, the magnitude of the limiting current I_{LIM} changes so as to cancel out the effect of the change. Thus, the dependency of the output current limit of the linear regulator 100 on the input voltage VDD is reduced.

As described above, the linear regulator 100 according to the first embodiment includes a current limiting circuit that restricts a variable range of the drive voltage Pdr of the output transistor PM1 within a predetermined range and thereby limiting the output current Io to the limiting current I_{LIM} or less. Since the second reference current Is, which determines the limiting current I_{LIM}, has a dependency on the input voltage VDD, the dependency of the limiting current V_{LIM} on the input voltage VDD is cancelled out. More specifically, a positive correlation between the limiting current V_{LIM} and the input voltage VDD is cancelled out by a negative correlation between the second reference current Is and the input voltage VDD. Due to such features, the linear regulator 100 according to the first embodiment can reduce the dependency of the output current limit on the input voltage VDD.

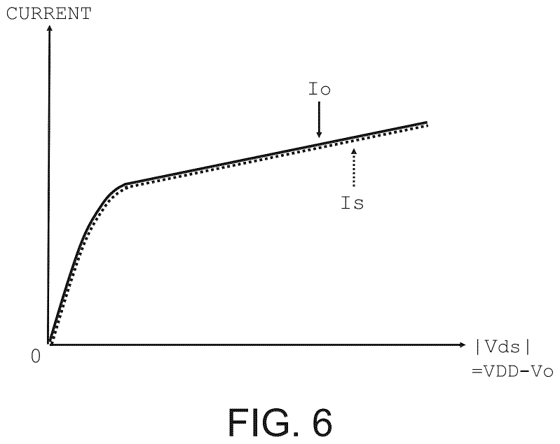

Most preferably, a dependency characteristic of the drain-source current Ip of the transistor PM6 on the input voltage VDD coincides with a dependency characteristic of the output current Io on the input voltage VDD, as illustrated in FIG. 6. In order to do so, a channel length modulation coefficient 26 of the transistor PM6 is preferably equal to a channel length modulation coefficient \1 of the output transistor PM1. Moreover, a gate length L6 of the transistor PM6 is preferably equal to a gate length L1 of the output transistor PM1. Furthermore, the drain-source voltage |Vds6|=VDD−Vn of the transistor PM6 is preferably equal to the drain-source voltage |Vds|=VDD−Vo of the output transistor PM1, that is, the setting voltage Vn of the first node N1 is preferably equal to the output voltage Vo. However, even when these values are slightly different, as long as there is a rough similarity between the characteristics of the second reference current Is and the characteristics of the output current Io, the dependency of the output current limit on the input voltage VDD can be reduced.

### Second Embodiment

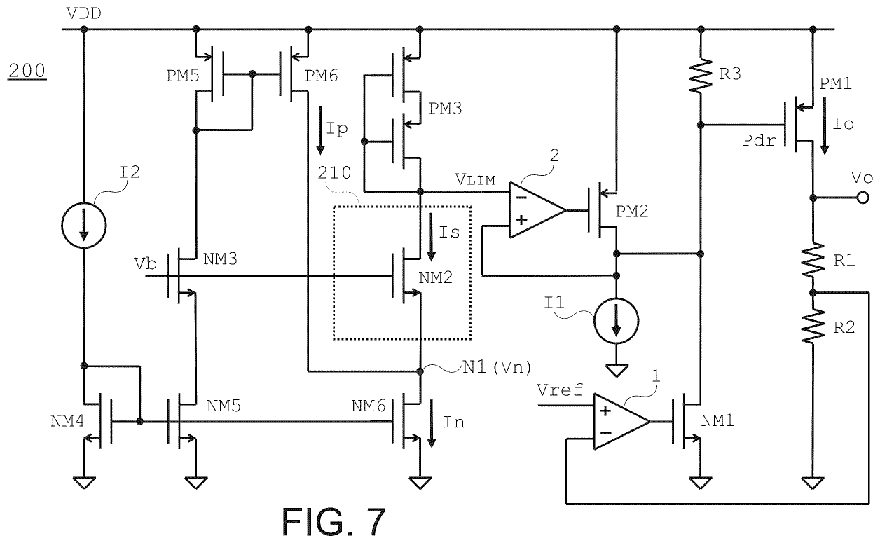

FIG. 7 is a diagram illustrating a configuration of a linear regulator 200 according to a second embodiment. A bias voltage Vb used in a cascode current mirror circuit formed by transistors NM3 to NM5 is input to a gate of a transistor NM2 of a first voltage fixing circuit 210. Accordingly, the constant voltage source V1 required in the first embodiment cannot be provided, and thus a circuit scale can be reduced. Further, most preferably, the bias voltage satisfies a relationship of Vb=Vo+Vth, but even when such a relationship is not perfectly satisfied, the dependency of the output current limit on the input voltage VDD can be reduced as long as such a relationship is closely satisfied.

### Third Embodiment

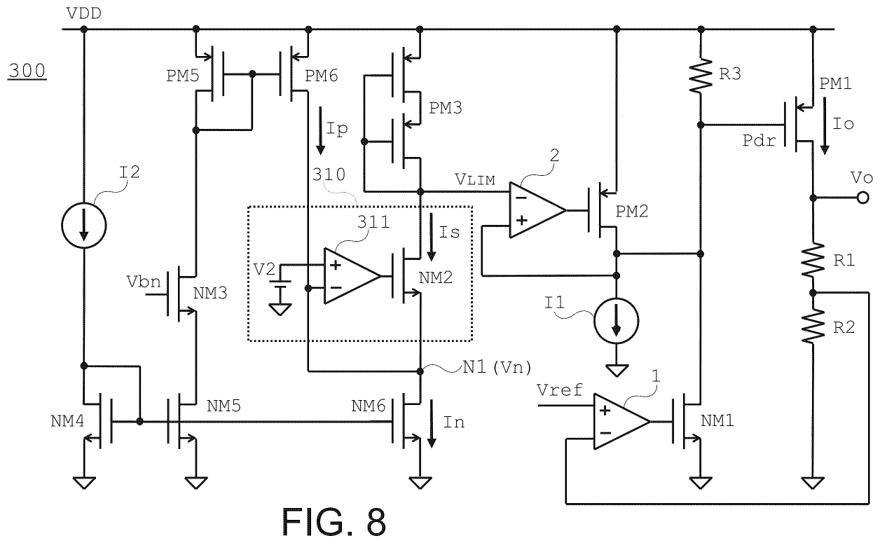

FIG. 8 is a diagram illustrating a configuration of a linear regulator 300 according to a third embodiment. An output signal of an error amplifier 311 (a first error amplifier) is input to a gate of a transistor NM2 of a first voltage fixing circuit 310. The error amplifier 311 outputs a comparison result between a voltage of a first node N1 and a setting voltage Vn generated by a constant voltage source V2. In detail, a positive input terminal of the error amplifier 311 is connected to the constant voltage source V2 that generates the setting voltage Vn=Vo. A negative input terminal of the error amplifier 311 is connected to the first node N1. Accordingly, the voltage of the first node N1 is fixed to the setting voltage Vn=Vo. Even with such a configuration, the dependency of the output current limit on the input voltage VDD can be reduced.

### Fourth Embodiment

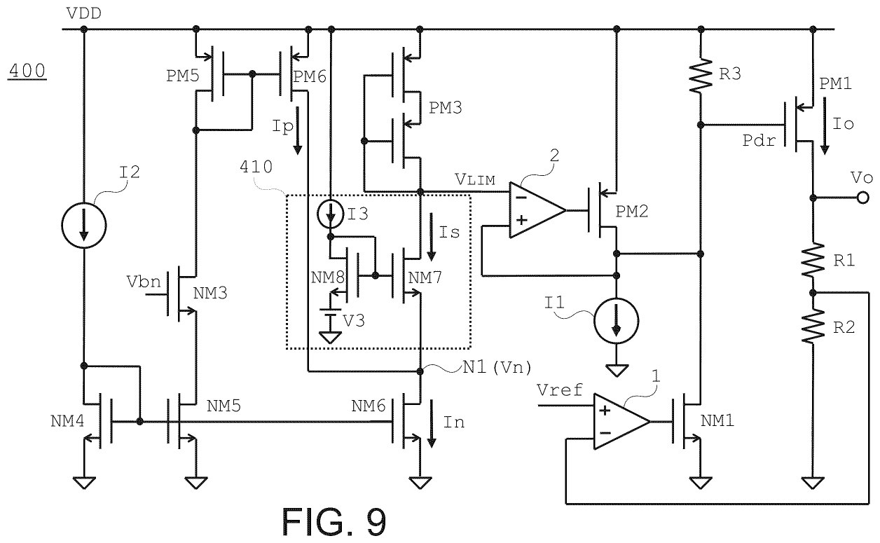

FIG. 9 is a diagram illustrating a configuration of a linear regulator 400 according to a fourth embodiment. A first voltage fixing circuit 410 includes a current mirror circuit formed by a transistor NM7 (a fifth transistor) and a transistor NM8 (a sixth transistor). A drain of the transistor NM7 is connected to a drain of a diode-connected transistor PM3. A source of the transistor NM7 is connected to a first node N1. A drain of the transistor NM8 is connected to a constant current source 13. A source of the transistor NM8 is connected to a constant voltage source V3 that generates a setting voltage Vn=Vo. Accordingly, the voltage of the first node N1 is fixed to the setting voltage Vn=Vo. Even with such a configuration, the dependency of the output current limit on the input voltage VDD can be reduced.

### Fifth Embodiment

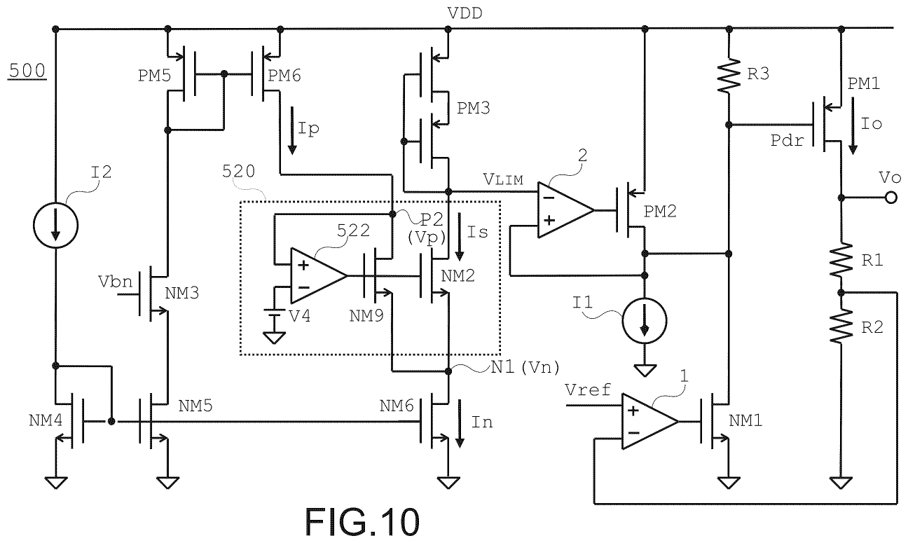

FIG. 10 is a diagram illustrating a configuration of a linear regulator 500 according to a fifth embodiment. A second voltage fixing circuit 520 fixes a voltage of a drain (a second node P2) of a transistor PM6 to a predetermined setting voltage Vp (a second setting voltage)=Vo. In detail, an output signal of an error amplifier 522 (a second error amplifier) is input to a gate of a transistor NM2 of the voltage fixing circuit 520 and a gate of a transistor NM9 (a seventh transistor) that has a mirror relationship with the transistor NM2. A drain of the transistor NM9 is connected to the second node P2. The error amplifier 522 outputs a comparison result between the voltage of the second node P2 and the setting voltage Vp generated by a constant voltage source V4. Accordingly, the voltage of the second node P2 is fixed to the setting voltage Vp=Vo. As a result, a drain-source voltage Vds2 (=VDD-Vp) of the transistor PM6 satisfies VDD-Vo. Even with such a configuration, the dependency of the output current limit on the input voltage VDD can be reduced.

### Sixth Embodiment

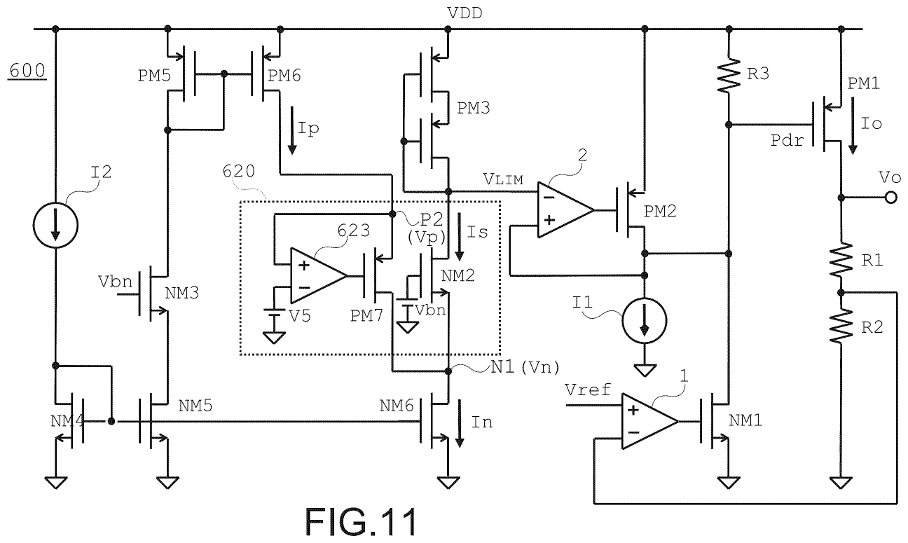

FIG. 11 is a diagram illustrating a configuration of a linear regulator 600 according to a sixth embodiment. A second voltage fixing circuit 620 fixes a voltage of a drain (a second node P2) of a transistor PM6 to a setting voltage Vp=Vo. In detail, an output signal of an error amplifier 623 (a third error amplifier) is input to a gate of a transistor PM7 (an eighth transistor) of the voltage fixing circuit 620. A source of the transistor PM7 is connected to the second node P2. A drain of the transistor PM7 is connected to a first node N1. The error amplifier 623 outputs a comparison result between the voltage of the second node P2 and the setting voltage Vp generated by a constant voltage source V5. Accordingly, the voltage of the second node P2 is fixed to the setting voltage Vp=Vo. As a result, a drain-source voltage Vds2 (=VDD-Vp) of the transistor PM6 satisfies VDD-Vo. Even with such a configuration, the dependency of the output current limit on the input voltage VDD can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments of the present invention can also be configured as follows.

### CLAUSES

Clause 1. An electronic circuitry comprising:
a first transistor connected between an input voltage line and an output terminal, an input voltage being supplied to the input voltage line; and
a current limiting circuit configured to limit an output current of the first transistor to a limiting current or less by restricting a variable range of a drive voltage of the first transistor within a predetermined range, the limiting current being determined by a reference voltage having a dependency on the input voltage.

Clause 2. The electronic circuitry according to clause 1, wherein a negative correlation between the reference current and the input voltage cancels out a positive correlation between the limiting current and the input voltage.

Clause 3. (first to fourth embodiments) An electronic circuitry comprising:
a first transistor connected between an input voltage line and an output terminal, an input voltage being supplied to the input voltage line;
a second transistor connected between the input voltage line and a first node;
a current limiting circuit including a third diode-connected transistor and an error amplifier;
a constant current circuit configured to keep a total of a reference current and an output current of the second transistor constant; and
a first voltage fixing circuit connected to the third transistor and configured to fix a voltage of the first node to a predetermined first setting voltage.

Clause 4. The electronic circuitry according to clause 3, wherein
the second transistor has a channel length modulation coefficient equal to that of the first transistor.

Clause 5. The electronic circuitry according to clause 3 or 4, wherein
the second transistor has a gate length equal to that of the first transistor.

Clause 6. The electronic circuitry according to any one of clauses 3 to 5, wherein
the predetermined first setting voltage is equal to an output voltage of the output terminal.

Clause 7. (first embodiment) The electronic circuitry according to any one of clauses 3 to 6, wherein
the first voltage fixing circuit includes a fourth transistor, a source of the fourth transistor being connected to the first node,
the reference current flows between a drain of the fourth transistor and the source of the fourth transistor, and
the predetermined first setting voltage plus a threshold voltage is input to a gate of the fourth transistor.

Clause 8. (second embodiment) The electronic circuitry according to any one of clauses 3 to 6, wherein
the first voltage fixing circuit includes a fourth transistor, a source of the fourth transistor being connected to the first node,
the reference current flows between a drain of the fourth transistor and the source of the fourth transistor, and
a bias voltage of a current mirror circuit is input to a gate of the fourth transistor.

Clause 9. (third embodiment) The electronic circuitry according to any one of clauses 3 to 6, wherein
the first voltage fixing circuit includes:
a fourth transistor having a source connected to the first node; and
a first error amplifier configured to output a comparison result between the voltage of the first node and the predetermined first setting voltage,
the reference current flows between a drain of the fourth transistor and the source of the fourth transistor, and
an output signal of the first error amplifier is input to a gate of the fourth transistor.

Clause 10. (fourth embodiment) The electronic circuitry according to any one of clauses 3 to 6, wherein
the first voltage fixing circuit includes a current mirror circuit formed by a fifth transistor and a sixth transistor,
the reference current flows between a drain of the fifth transistor and a source of the fifth transistor,
the sixth transistor has a source connected to the first node, and
the predetermined first setting voltage is input to the source of the sixth transistor.

Clause 11. The electronic circuitry according to any one of clauses 3 to 10, further comprising
a voltage control circuit configured to control an on-resistance of the first transistor by controlling a drive voltage of the first transistor.

Clause 12. (fifth and sixth embodiments) An electronic circuitry comprising:
a first transistor connected between an input voltage line and an output terminal, an input voltage being supplied to the input voltage line;
a second transistor connected to the input voltage line and a first node;
a third diode-connected transistor configured to generate a reference voltage by generating a reference current corresponding to the input voltage;
a current limiting circuit configured to limit an output current of the first transistor to a limiting current or less by restricting a variable range of a drive voltage of the first transistor within a predetermined range, the limiting current depending on the reference voltage;
a constant current circuit configured to keep a total of the reference current and an output current of the second transistor constant; and
a second voltage fixing circuit configured to fix a drain-source voltage of the second transistor to a predetermined second setting voltage.

Clause 13. The electronic circuitry according to clause 12, wherein
the second voltage fixing circuit includes:
a fourth transistor having a source connected to the first node;
a seventh transistor that has a mirror relationship with the fourth transistor; and
a second error amplifier configured to output a comparison result between a voltage of the second node being a drain of the second transistor, and the predetermined second setting voltage,
the reference current flows between a drain of the fourth transistor and the source of the fourth transistor,
the seventh transistor has a drain connected to the second node,
the seventh transistor has a source connected to the first node, and
the fourth transistor and the seventh transistor have gates, respectively, to which an output signal of the second error amplifier is input.

Clause 14. The electronic circuitry according to clause 12, wherein
the second voltage fixing circuit includes:
a fourth transistor having a source connected to the first node;
a third error amplifier configured to output a comparison result between a voltage of the second node being a drain of the second transistor, and the predetermined second setting voltage; and
an eighth transistor having a drain connected to the first node and having a source connected to the second node,
the reference current flows between a drain of the fourth transistor and the source of the fourth transistor,
an output signal of the third error amplifier is input a gate of the eighth transistor.

1. An electronic circuitry comprising:
a first transistor connected between an input voltage line and an output terminal, an input voltage being supplied to the input voltage line; and
a current limiting circuit configured to limit an output current of the first transistor to a limiting current or less by restricting a variable range of a drive voltage of the first transistor within a predetermined range, the limiting current being determined by a reference voltage having a dependency on the input voltage.

2. The electronic circuitry according to claim 1, wherein
a negative correlation between the reference current and the input voltage cancels out a positive correlation between the limiting current and the input voltage.

3. An electronic circuitry comprising:
a first transistor connected between an input voltage line and an output terminal, an input voltage being supplied to the input voltage line;
a second transistor connected between the input voltage line and a first node;
a current limiting circuit including a third diode-connected transistor and an error amplifier;
a constant current circuit configured to keep a total of a reference current and an output current of the second transistor constant; and
a first voltage fixing circuit connected to the third transistor and configured to fix a voltage of the first node to a predetermined first setting voltage.

4. The electronic circuitry according to claim 3, wherein
the second transistor has a channel length modulation coefficient equal to that of the first transistor.

5. The electronic circuitry according to claim 3, wherein
the second transistor has a gate length equal to that of the first transistor.

6. The electronic circuitry according to claim 3, wherein
the predetermined first setting voltage is equal to an output voltage of the output terminal.

7. The electronic circuitry according to claim 3, wherein
the first voltage fixing circuit includes a fourth transistor, a source of the fourth transistor being connected to the first node,
the reference current flows between a drain of the fourth transistor and the source of the fourth transistor, and
the predetermined first setting voltage plus a threshold voltage is input to a gate of the fourth transistor.

8. The electronic circuitry according to claim 3, wherein
the first voltage fixing circuit includes a fourth transistor, a source of the fourth transistor being connected to the first node,
the reference current flows between a drain of the fourth transistor and the source of the fourth transistor, and
a bias voltage of a current mirror circuit is input to a gate of the fourth transistor.

9. The electronic circuitry according to claim 3, wherein
the first voltage fixing circuit includes:
a fourth transistor having a source connected to the first node; and
a first error amplifier configured to output a comparison result between the voltage of the first node and the predetermined first setting voltage,
the reference current flows between a drain of the fourth transistor and the source of the fourth transistor, and
an output signal of the first error amplifier is input to a gate of the fourth transistor.

10. The electronic circuitry according to claim 3, wherein
the first voltage fixing circuit includes a current mirror circuit formed by a fifth transistor and a sixth transistor,
the reference current flows between a drain of the fifth transistor and a source of the fifth transistor,
the sixth transistor has a source connected to the first node, and
the predetermined first setting voltage is input to the source of the sixth transistor.

11. The electronic circuitry according to claim 3, further comprising
a voltage control circuit configured to control an on-resistance of the first transistor by controlling a drive voltage of the first transistor.

12. An electronic circuitry comprising:
a first transistor connected between an input voltage line and an output terminal, an input voltage being supplied to the input voltage line;
a second transistor connected to the input voltage line and a first node;
a third diode-connected transistor configured to generate a reference voltage by generating a reference current corresponding to the input voltage;
a current limiting circuit configured to limit an output current of the first transistor to a limiting current or less by restricting a variable range of a drive voltage of the first transistor within a predetermined range, the limiting current depending on the reference voltage;
a constant current circuit configured to keep a total of the reference current and an output current of the second transistor constant; and
a second voltage fixing circuit configured to fix a drain-source voltage of the second transistor to a predetermined second setting voltage.

13. The electronic circuitry according to claim 12, wherein
the second voltage fixing circuit includes:
a fourth transistor having a source connected to the first node;
a seventh transistor that has a mirror relationship with the fourth transistor; and
a second error amplifier configured to output a comparison result between a voltage of the second node being a drain of the second transistor, and the predetermined second setting voltage,
the reference current flows between a drain of the fourth transistor and the source of the fourth transistor,
the seventh transistor has a drain connected to the second node,
the seventh transistor has a source connected to the first node, and
the fourth transistor and the seventh transistor have gates, respectively, to which an output signal of the second error amplifier is input.

14. The electronic circuitry according to claim 12, wherein
the second voltage fixing circuit includes:
a fourth transistor having a source connected to the first node;
a third error amplifier configured to output a comparison result between a voltage of the second node being a drain of the second transistor, and the predetermined second setting voltage; and
an eighth transistor having a drain connected to the first node and having a source connected to the second node,
the reference current flows between a drain of the fourth transistor and the source of the fourth transistor,
an output signal of the third error amplifier is input a gate of the eighth transistor.
